(19) United States
(12) Patent Application Publication
(10) Pub. No.: US 2012/0319963 A1
(43) Pub. Date: Dec. 20, 2012

(54) TOUCH PANEL

(75) Inventors: In Hyung LEE, Gyunggi-do (KR); Sang Su HONG, Gyunggi-do (KR); Jae Hun KIM, Seoul (KR); Chung Mo YANG, Gyunggi-do (KR); Woo Jin LEE, Seoul (KR); Young Woo LEE, Gyunggi-do (KR)

(73) Assignee: SAMSUNG ELECTRO-MECHANICS CO., LTD., Gyunggi-do (KR)

(21) Appl. No.: 13/327,108

(22) Filed: Dec. 15, 2011

(30) Foreign Application Priority Data
Jun. 14, 2011 (KR) 10-2011-0057651

(51) Int. Cl. G06F 3/041

(52) U.S. Cl. 345/173

(57) ABSTRACT

Disclosed herein is a touch panel including a base member; a transparent electrode formed on the base member and made of metal; and gloss reduction layers formed on the transparent electrode. The gloss reduction layers tinged with a dark color are formed on the transparent electrode made of metal to block metallic gloss, thereby making it possible to prevent the transparent electrode from being viewed and reduce reflectivity on the surface of the transparent electrode. In addition, the transparent electrode made of metal is patterned in a mesh shape, thereby making it possible to enhance light transmitivity of the touch panel.

### CROSS REFERENCE TO RELATED APPLICATION

This application claims the benefit of Korean Patent Application No. 10-2011-0057651, filed on Jun. 14, 2011, entitled “Touch Panel” which is hereby incorporated by reference in its entirety into this application.

### BACKGROUND OF THE INVENTION

1. Technical Field

The present invention relates to a touch panel.

2. Description of the Related Art

As computers using digital techniques develop, computer assisted devices have also correspondingly been developed, and personal computers, portable transmission apparatus, other personal information processing apparatus, or the like perform text and graphic processes using various input devices, such as a keyboard or a mouse.

With the rapid advancement of an information-oriented society widening the use of computers more and more, problems have come alight in that it is difficult to efficiently operate products using only the keyboard and mouse as being currently responsible for the input device function. Thus, the demand for a device that is simple, has minimum malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display device including a liquid crystal display (LCD) device, a plasma display panel (PDP), an electroluminescence (El), or the like, or a cathode ray tube (CRT), so that a user selects desired information while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical characteristic, electrical properties, mechanical properties, resistance to the environment, input properties, durability and economic benefits of the touch panel. In particular, resistive and capacitive types are prevalently used in a broad range of fields currently.

The resistive type touch panel has a structure in which upper/lower transparent electrode films are disposed to be spaced by a spacer and be contacted with each other by a touch. In the resistive type of touch panel, when an upper touch panel formed with the upper transparent electrode film is pressed by an input unit such as fingers, pens, or the like, the upper/lower transparent electrode films are conducted and a change in voltage according to a change in resistance value in the position is recognized by a controller, such that the touched coordinates are recognized. As the resistive type of touch panel, there are a digital resistive type of touch panel and an analog resistive type of touch panel.

In the capacitive type touch panel, the upper substrate on which the first electrode pattern is formed and the lower substrate on which the second electrode pattern is formed are spaced from each other and an insulator is inserted therebetween to prevent the first electrode pattern from contacting the second electrode pattern. In addition, the upper substrate and the lower substrate are formed with electrode wirings connected to the electrode patterns. The electrode wirings transfer the change in capacitance generated in the first electrode pattern and the second electrode pattern according to the touch of the input unit with the touch screen to a controller.

In the prior art, indium tin oxide (ITO) or a conductive polymer such as polyethylene dioxythiophene/polystyrenesulfonate (PEDOT/PSS) was used to form transparent electrodes. ITO has excellent electric conductivity, but a raw material thereof, that is, indium is a rare earth metal and thus expensive, and besides, it is expected to run out in 10 years and therefore, supply and demand will not be smooth. The conductive polymer, which is a material used to substitute the ITO, has excellent flexibility and easy processability, but it has decreased electric conductivity.

For this reason, studies for forming a transparent electrode by using metal have progressed. The transparent electrode made of metal has more excellent electric conductivity and more smooth supply and demand, as compared with the ITO or the conductive polymer. However, in the case of the transparent electrode made of metal, a problem arises in that the transparent electrode is viewed by a user due to a peculiar gloss of the metal.

### SUMMARY OF THE INVENTION

The present invention has been made in an effort to provide a touch panel having good visibility by reducing metallic gloss of a transparent electrode made of metal and enhancing transmitivity thereof.

According to an exemplary embodiment of the present invention, there is provided a touch panel, including: a base member; a transparent electrode formed on the base member and made of metal; and gloss reduction layers formed on the transparent electrode.

The gloss reduction layer may be formed on a surface in contact with the base member of the transparent electrode.

The gloss reduction layer may be formed on an opposite surface to the surface in contact with the base member of the transparent electrode.

The gloss reduction layers may be formed on both of the surface in contact with the base member of the transparent electrode and the opposite surface to the surface in contact with the base member of the transparent electrode.

The transparent electrode may be patterned to have a mesh shape. The transparent electrode may be made of copper (Cu), aluminum (Al), gold (Au), silver (Ag), or a combination thereof.

The transparent electrode may be made of titanium (Ti), palladium (Pd), chrome (Cr), or a combination thereof.

The gloss reduction layer may be made of copper oxide I (Cu2O), copper oxide II (CuO), aluminum oxide (Al₂O₃), silver oxide (AgO), titanium oxide (TiO₂), palladium oxide (PdO), or chrome oxide (Cr_{X}O_{Y}),

The gloss reduction layer may be made of titanium (Ti), palladium (Pd), chrome (Cr), or a combination thereof.

The gloss reduction layer may be made of any one of polythiophene-based, polypyrrole-based, polyphenylene-based, polyaniline-based, and polyacetylenes-based conductive polymers.

The gloss reduction layer may have a thickness of 0.01 μm to 1 μm.

The transparent electrode may have a thickness of 0.01 μm to 2 μm.

The gloss reduction layer and the transparent electrode may have a line width of 5 μm to 10 μm.

### BRIEF DESCRIPTION OF THE DRAWINGS

FIGS. 1 to 3 are cross-sectional views of a transparent electrode according to a preferred embodiment of the present invention;

FIG. 4 is a cross-sectional view of a two-layer type touch panel according to a preferred embodiment of the present invention;

FIG. 5 is a cross-sectional view of a one-layer type touch panel according to a preferred embodiment of the present invention, the one-layer type touch panel in which transparent electrodes are formed on both surfaces of a base member;

FIG. 6 is a plan view of a touch panel according to a preferred embodiment of the present invention in which a transparent electrode is patterned in a mesh shape;

FIG. 7 is an enlarged view of part A of the transparent electrode shown in FIG. 6; and

FIGS. 8 and 9 are partially enlarged views showing modified examples of mesh shape.

### DESCRIPTION OF THE PREFERRED EMBODIMENTS

Various objects, advantages and features of the invention will become apparent from the following description of embodiments with reference to the accompanying drawings

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, a detailed description thereof will be omitted.

Hereinafter, exemplary embodiments of the present invention will be described in detail with reference to the accompanying drawings.

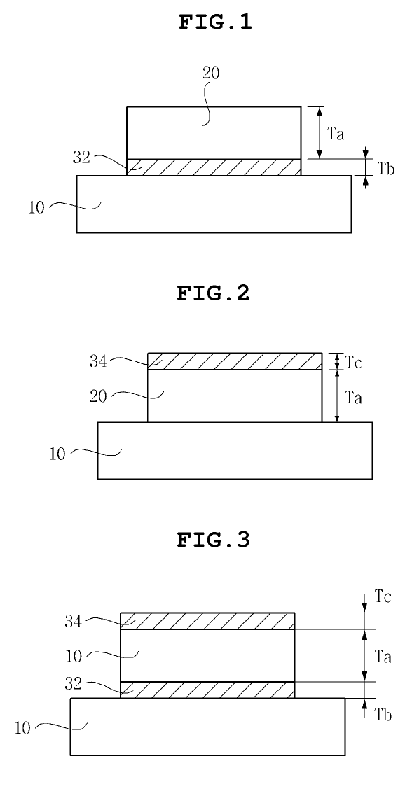

A touch panel according to the present invention is configured to include a base member 10, a transparent electrode 20 formed on the base member 10 and made of metal, and gloss reduction layers 32 and 34 formed on the transparent electrode 20, as shown in FIGS. 1 to 3. The present invention includes the gloss reduction layers 32 and 34 formed on the transparent electrode 20 and having colors to block peculiar gloss of the metal, thereby making it possible to prevent the transparent electrode 20 from being viewed. In addition, the present invention reduces light incident directly on the surface of the transparent electrode 20 from the outside, thereby making it possible to decrease reflectivity of the transparent electrode 20. Therefore, images transmitted from a display positioned under the touch panel are transferred to a user by penetrating through the touch panel without interference, thereby making it possible to improve visibility of a device to which the touch panel is applied such as a cellular phone, a TV, or the like. Hereinafter, the touch panel will be described in detail according to the components thereof.

First, the base member 10 of the present invention is made of a material having supporting force supporting the transparent electrode 20 and transparency allowing a user to recognize the images provided from the display. The material of the base member 10 may include polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; containing K resin), glass or reinforced glass, and so on, without being particularly limited thereto.

Next, the transparent electrode 20 according to the present invention is formed on the base member 10, the transparent electrode 20 being made of metal. The transparent electrode 20 is a portion at which a change in capacitance (a capacitive type) or a change in resistance value (a resistive type) is sensed when the touch screen is touched by a user's hand. As a metal material configuring the transparent electrode 20, copper (Cu), aluminum (Al), silver (Ag), gold (Au), titanium (Ti), palladium (Pd), chrome (Cr), or a combination thereof may be used. The transparent electrode 20 is preferably made of a material having high electrical conductivity, such as copper (Cu), aluminum (Al), gold (Au), and silver (Ag). However, the material thereof is not limited thereto but all metals having high electrical conductivity and easy processability may be used for the transparent electrode 20.

As shown in FIGS. 1 to 3, the present invention forms the gloss reduction layers 32 and 34 on the transparent electrode 20 to reduce metallic gloss of the transparent electrode 20, thereby making it possible to prevent the transparent electrode 20 from being viewed from the outside. The metallic gloss means peculiar gloss that may be seen from a cross-section of the metal element mineral such as gold (Au), silver (Ag), and copper (Cu), sulfide mineral, oxide mineral, and the like generally have metallic gloss. The metallic gloss is based on selective absorption and reflection of light depending on different reflectivity on the cross-section of the metal according to the wavelength of light. In the prior art, a separate chemical treatment is performed so as to remove the metallic gloss of the transparent electrode 20 made of metal, such that the process thereof becomes complicated and the manufacturing costs thereof increases. In the present invention, however, the gloss reduction layers 32 and 34 are formed on the transparent electrode 20 using an existing process device such as a silk screen device, an inkjet printing device, or the like, used when forming the transparent electrode 20 on the base member 10, such that the process time is shorten and the manufacturing costs thereof is reduced.

In addition, the gloss reduction layers 32 and 34 blocks external light incident on the surface of the transparent electrode 20 to reduce light reflected on the surface of the transparent electrode 20, such that reflectivity of the touch panel may be reduced. Therefore, when the touch panel is used in an outdoor environment where sunshine is strong, glaring due to light reflection is reduced, such that visibility of the touch panel is improved.

The gloss reduction layers 32 and 34 may be formed on a surface in contact with the base member 10 of the transparent electrode 20 (see FIG. 1) or be formed on an opposite surface to the surface in contact with the base member 10 (see FIG. 2) or on both surfaces thereof (see FIG. 3). When the transparent electrode 20 is patterned to have a certain shape, the gloss reduction layers 32 and 34 are formed on one surface or both surfaces of the transparent electrode 20 so that they correspond to the shape of the patterned transparent electrode 20.

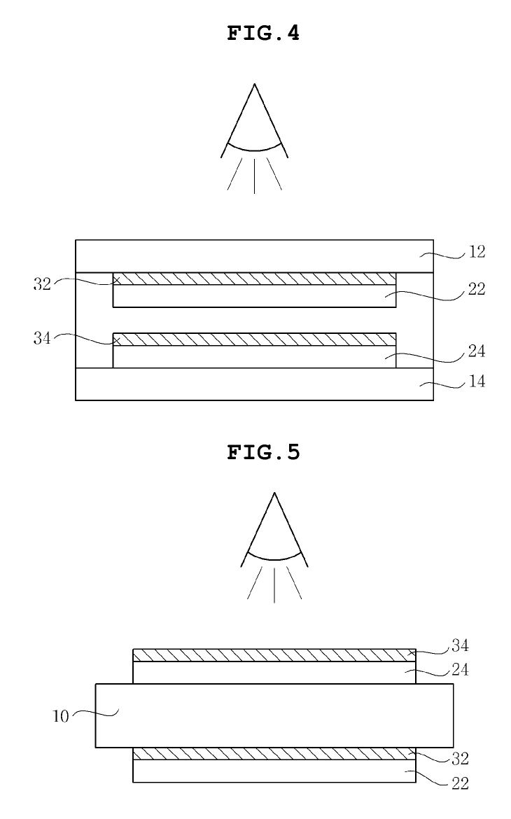

When the gloss reduction layer 32 of FIG. 1 is formed on the surface in contact with the base member 10 of the transparent electrode 20, it serves to prevent metallic gloss of the contact surface with the base member 12 of the transparent electrode 22 formed on the upper base member 12, as in the two-layer type touch panel including upper and lower base members 12 and 14 shown in FIG. 4. When the transparent electrodes 22 and 24 are formed on both surfaces of the single base member 10 as shown in FIG. 5, the gloss reduction layer serves to prevent metallic gloss of the transparent electrode 22 formed on the opposite surface to the surface of the base member 10 facing a user.

When the gloss reduction layer 34 of FIG. 2 is formed on the opposite surface to the surface in contact with the base member 10 of the transparent electrode 20, it may prevent metallic gloss on the surface of the transparent electrode 24 formed on the lower base member 14 of the two-layer type touch panel, as shown in FIG. 4. As shown in FIG. 5, the gloss reduction layer may be also used to prevent metallic gloss of the transparent electrode 24 formed on the surface of the base member 10 facing the user in the one-layer type touch panel.

Furthermore, as shown in FIG. 3, the gloss reduction layers 32 and 34 are formed on both surfaces of the transparent electrode 20, whereby the process may be different according to the position of the transparent electrode 20 to thereby remove an inconvenience of forming the gloss reduction layers 32 and 34 and the base member 10 on which the transparent electrode 20 may be used without being divided into the upper base member or the lower base member.

In this case, the gloss reduction layers 32 and 34 may be made of a metal oxide such as copper oxide I (Cu₂O), copper oxide II (CuO), aluminum oxide (Al₂O₃), silver oxide (AgO), titanium oxide (TiO₂), palladium oxide (PdO), chrome oxide (Cr_{X}O_{Y}), or the like. The metal oxide, which is formed by reacting metal with oxygen (O₂), loses peculiar gloss of metal when metal is oxidized to be thereby tinged with a dark color such as black, gray, dark red, and the like. The metal oxide tinged with a dark color blocks a metallic gloss reflected on the transparent electrode 20 to thereby allow the gloss of the transparent electrode 20 not to be viewed by the user. The gloss reduction layers 32 and 34 of the metal oxide may be formed by oxidizing the surface of the metal forming the transparent electrode 20, without a separate deposition process, thereby providing convenience in the process. The gloss reduction layers 32 and 34 may also be formed by the deposition of oxides of different metals as well as the metal oxide of the transparent electrode 20.

In addition, the gloss reduction layers 32 and 34 may be made of titanium (Ti), palladium (Pd), chrome (Cr), or a combination thereof. The metals are tinged with a dark color, thereby making it possible to block the metallic gloss of the transparent electrode 20 in the same principle of the metal oxide. Preferably, copper (Cu), aluminum (al), gold (Au), or silver (Ag) having high electrical conductivity is used as the transparent electrode 20, and titanium (Ti), palladium (Pd), or chrome (Cr) is used as the metal gloss reduction layers 32 and 34.

In addition, the gloss reduction layers 32 and 34 may also be made of a polythiophene-based, polypyrrole-based, polyphenylene-based, polyaniline-based, or polyacetylene-based conductive polymer. The conductive polymer material is generally tinged with light blue, thereby reducing the gloss of the transparent electrode 20 made of metal.

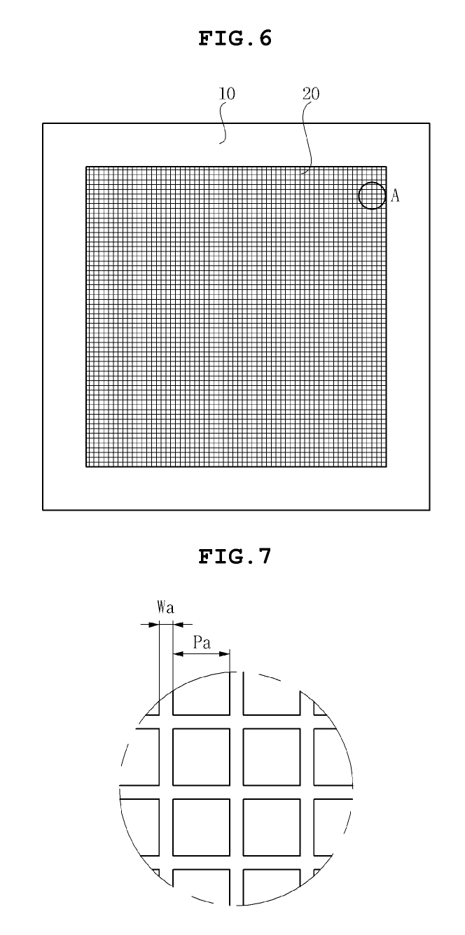

Meanwhile, the transparent electrode 20 may be patterned in a mesh shape, as shown in FIG. 6. The mesh shape generally means a shape in which a plurality of square openings are uniformly arranged with respect to a predetermined area. When the transparent electrode 20 is made of metal, it has high electrical conductivity but has opaque metal color, thereby leading to low light transmitivity (a ratio of transmitting light over incident light) of the touch panel. When the transparent electrode 20 is formed in a mesh shape in a predetermined area, an opening ratio (a ratio of an opening area over the overall area) can reach 95% to 99.5%, if the pitch size of the mesh is minutely set to several micrometers. When the opening ratio of the transparent electrode 20 increases, light transmitivity of the touch panel also increases. Therefore, an image from the display may reach the user by penetrating through the touch panel without interruption. Meanwhile, a pitch Pa of the mesh means a length of one side of the opening of a single square and a line width Wa means a width of a patterned single metal line surrounding the opening, as shown in FIG. 7.

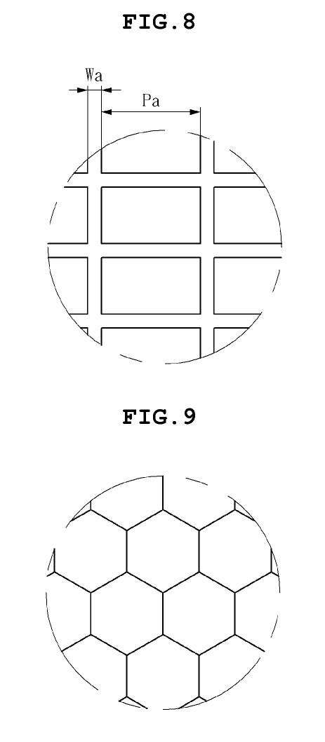

The mesh shape is not limited to the opening in a square shape and may be a polygonal-shape opening such as a quadrangular-shape opening (see FIG. 8), a hexagonal-shape opening (see FIG. 9), or the like, an oval-shape opening, or a circular-shape opening.

In this case, the transparent electrode 20 and the gloss reduction layers 32 and 34 may preferably have a line width Wa of 5 μm to 10 μm. Within the range, the touch panel has excellent light transmitivity of 88% or higher and the transparent electrode 20 also has a good electrical conductivity.

As shown in FIGS. 1 to 3, the transparent electrode 20 may have a thickness Ta of 0.01 μm to 2 μm. When the transparent electrode 20 has a thickness Ta below 0.01 μm electrical conductivity may be degraded, and when the transparent electrode 20 has a thickness Ta exceeding 2 μm, the light transmittance of the touch panel may be degraded.

The gloss reduction layers 32 and 34 may have thicknesses Tb and Tc of 0.01 μm to 1 μm. When the gloss reduction layers 32 and 34 have thicknesses Tb and Tc below 0.01 μm, the gloss reduction of the transparent electrode 20 is insignificant, and when the gloss reduction layers 32 and 34 have thicknesses Tb and Tc exceeding 1 μm the light transmittance may be degraded.

Meanwhile, the transparent electrode 20 in a mesh shape may be formed on the base member by plating, sputtering, or depositing the metal thereon or by silk screening, gravure printing, or inkjet printing the metal thereon. The gloss reduction layers 32 and 34 may also be formed on the transparent electrode 20 using the same method as the transparent electrode 20.

Hereinafter, the present invention will be described in more detail by the following examples but is not limited thereto.

### Example 1

A PET film having a thickness of 1 mm was used as a base member. A transparent electrode was patterned in a mesh shape on the base member using copper (Cu) and then, palladium (Pd) was deposited on the transparent electrode as a gloss reduction layer to thereby manufacture a touch panel. In this case, the transparent electrode had a thickness of 2 μm and the gloss reduction layer had a thickness of 1 μm. In addition, the transparent electrode and the gloss reduction layer had a line width of 10 μm.

### Example 2

It was performed in the same manner as Example 1, however, had different thicknesses and a line width from those in Example 1, wherein the transparent electrode had a thickness of 1 μm, the gloss reduction layer had a thickness of 0.5 μm, and the transparent electrode and the gloss reduction layer had a line width of 7 μm, to thereby manufacture a touch panel.

### Comparative Example

A PET film having a thickness of 1 mm was used as a base member. A transparent electrode was patterned in a mesh shape on a upper portion of the base member using copper (Cu) to thereby manufacture a touch panel. In this case, the transparent electrode had a thickness of 2 μm and a line width of 10 μm.

### Experimental Example

Transmittance and reflectivity of the touch panel and visibility of the transparent electrode in the Examples and the Comparative Example were evaluated. The transmitivity was evaluated with transmittance of UV-Visible 550 nm. Transmittance was measured using CM-3500d from the Minolta Company. The reflectivity was measured using an integrating sphere and was measured at 400 nm, 500 nm, 600 nm, and 700 nm, four times, according to a wavelength of incident light, to calculate an average value thereof. The visibility of the transparent electrode was evaluated by comparing Examples and Comparative Example with naked eyes.

TABLE 1

| | Transmitivity(%) | Reflectivity(%) | Visibility |
|---|---|---|---|
| Example 1 | 88% | 7% | X |
| Example 2 | 93.1% | 5% | X |
| Comparative | 89% | 60.1% | ◯ |
| Example | | | |

As may be appreciated from the experimental data values shown in Table 1, the touch panel having the gloss reduction layers formed on the metal transparent electrode in a mesh shape has lower reflectivity with respect to external light than that of the Comparative Example and has excellent visibility since the transparent electrode is not viewed by the user.

According to the preferred embodiment of the present invention, the gloss reduction layers are formed on the transparent electrode made of metal to reduce metallic gloss, thereby making it possible to prevent the transparent electrode from being viewed and reduce reflectivity on the surface of the transparent electrode.

In addition, the transparent electrode made of metal is patterned in a mesh shape, thereby making it possible to enhance light transmitivity of the touch panel.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, any and all modifications, variations or equivalent arrangements should be considered to be within the scope of the invention, and the detailed scope of the invention will be disclosed by the accompanying claims.

What is claimed is:

1. A touch panel, comprising:
a base member;
a transparent electrode formed on the base member and made of metal; and
gloss reduction layers formed on the transparent electrode.

2. The touch panel as set forth in claim 1, wherein the gloss reduction layer is formed on a surface in contact with the base member of the transparent electrode.

3. The touch panel as set forth in claim 1, wherein the gloss reduction layer is formed on an opposite surface to the surface in contact with the base member of the transparent electrode.

4. The touch panel as set forth in claim 1, wherein the gloss reduction layers are formed on both of the surface in contact with the base member of the transparent electrode and the opposite surface to the surface in contact with the base member of the transparent electrode.

5. The touch panel as set forth in claim 1, wherein the transparent electrode is patterned in a mesh shape.

6. The touch panel as set forth in claim 1, wherein the transparent electrode is made of copper (Cu), aluminum (Al), gold (Au), silver (Ag), or a combination thereof.

7. The touch panel as set forth in claim 1, wherein the transparent electrode is made of titanium (Ti), palladium (Pd), chrome (Cr), or a combination thereof.

8. The touch panel as set forth in claim 1, wherein the gloss reduction layer is made of copper oxide I (Cu₂O), copper oxide II (CuO), aluminum oxide (Al₂O₃), silver oxide (AgO), titanium oxide (TiO₂), palladium oxide (PdO), or chrome oxide (Cr_{X}O_{Y}).

9. The touch panel as set forth in claim 6, wherein the gloss reduction layer is made of titanium (Ti), palladium (Pd), chrome (Cr), or a combination thereof.

10. The touch panel as set forth in claim 1, wherein the gloss reduction layer is made of to any one of a polythiophene-based, polypyrrole-based, polyphenylene-based, polyaniline-based, and polyacetylenes-based conductive polymers.

11. The touch panel as set forth in claim 1, wherein the gloss reduction layer has a thickness of 0.01 μm to 1 μm.

12. The touch panel as set forth in claim 1, wherein the transparent electrode has a thickness of 0.01 μm to 2 μm.

13. The touch panel as set forth in claim 5, wherein the gloss reduction layer and the transparent electrode have a line width of 5 μm to 10 μm.
